(19) United States
(12) Patent Application Publication
(10) Pub. No.: US 2025/0128741 A1
(43) Pub. Date: Apr. 24, 2025

(54) CONVEYANCE DEVICE

(71) Applicant: NAKANISHI METAL WORKS CO., LTD., Osaka (JP)

(72) Inventor: Yoshihiro OKAZAKI, Osaka-shi (JP)

(73) Assignee: NAKANISHI METAL WORKS CO., LTD., Osaka (JP)

(21) Appl. No.: 18/917,787

(22) Filed: Oct. 16, 2024

(30) Foreign Application Priority Data
Oct. 20, 2023 (JP) 2023-181401

(51) Int. Cl. B61B 10/02

(52) U.S. Cl. CPC B61B 10/022

(57) ABSTRACT

At least one of a front trolley and a rear trolley, which are load trolleys, has a trolley frame, and a front sub-trolley and a rear sub-trolley which are positioned at a front and a rear of the trolley frame below the trolley frame. Each of the front sub-trolley and the rear sub-trolley has a sub-trolley body, a left bracket, a right bracket, and vertical rollers. The sub-trolley body is attached to the trolley frame so as to be rotatable about a first vertical shaft. The left bracket and the right bracket individually swing relative to the sub-trolley body around the first left-right shaft. The vertical rollers roll on a rail while being respectively supported by a second left-right shaft and a third left-right shaft of the left bracket and the right bracket.

### DESCRIPTION

### Field

The present invention relates to a conveyance device including a rail laid on a predetermined conveyance path and a carrier movable along the rail.

### Background

There is a conveyance device that includes a rail laid on a predetermined conveyance path and a carrier movable along the rail (see Patent Literature (PTL) 1, for example). In the carrier disclosed in PTL 1, front and rear trolleys, which are load trolleys for receiving loads of objects to be conveyed, and the like, are each provided with four vertical rollers on the front, back, left and right of each load trolley, and the vertical rollers roll on the rail. The loads of the objects to be conveyed and the like are received by the rail via the vertical rollers.

### CITATION LIST

### Patent Literature

PTL 1: Japanese Patent No. 3502977

### SUMMARY

### Technical Problem

The vertical rollers are attached to opposite ends of a left-right shaft that is provided in each of a front and a rear of the load trolley and passes through a base of the load trolley. The left-right shafts supporting the vertical rollers cannot move up or down relative to the base, and thus the vertical rollers cannot move up or down relative to the base.

The rail may be curved upward or downward, or placed horizontally but has minute undulations. In such a situation, when the four vertical rollers (front, rear, left, and right) roll on the rail, some of the four vertical rollers may not contact the rail. Even if all the four rollers are grounded on the rail, the load may be unevenly distributed on a particular vertical roller.

Accordingly, the load borne by the four vertical rollers (front, rear, left, and right) is not uniform, and the load is not proportionate for the four rollers, causing some vertical rollers to bear a large load. A surface pressure applied to the rail from vertical rollers bearing a large load increases, and thus wear of the rail is accelerated early and a service life of the rail is shortened.

Meanwhile, in automobile manufacturing plants, for example, a trend toward electric vehicles (EVs) requires conveyance of heavy vehicles equipped with large batteries. Recently, there has been an increasing demand for conveying heavy loads. However, in a configuration in which each load trolley has four vertical rollers on the front, back, left and right, as in a conventional carrier, the above problems become more evident, and the above requirements cannot be met.

An object of the present invention is to prevent early wear of a rail and to meet the demand for conveying objects with heavy weight, by allowing all vertical rollers provided on a load trolley to be securely grounded on a rail to cause all vertical rollers to bear the load in a distributed manner, in a conveyance device including a rail laid on a predetermined conveyance path and a carrier movable along the rail.

### Solution to Problem

A conveyance device according to a first aspect of the present invention relates to a conveyance device including a rail laid on a predetermined conveyance path and a carrier movable along the rail. The carrier includes: an object support unit that supports an object to be conveyed; and a front trolley and a rear trolley that are load trolleys supporting the object support unit. At least one of the front trolley and the rear trolley includes: a trolley frame; a front sub-trolley and a rear sub-trolley respectively positioned at a front and a rear of the trolley frame above or below the trolley frame. Each of the front sub-trolley and the rear sub-trolley includes a sub-trolley body, a left bracket, a right bracket, and vertical rollers. The sub-trolley body is attached to the trolley frame so as to be rotatable about a first vertical shaft. The left bracket and the right bracket are respectively positioned on a left side and a right side of the sub-trolley body to extend in a front-rear direction, each of the left bracket and the right bracket being supported at a middle position thereof in the front-rear direction by a first left-right shaft, and swinging relative to the sub-trolley body. Each of the vertical rollers is supported by a second left-right shaft at a front end portion of each of the left bracket and the right bracket, and a third left-right shaft at a rear end portion of each of the left bracket and the right bracket, and rolls on the rail.

With the configuration of the conveyance device according to the first aspect, each of the front sub-trolley and the rear sub-trolley provided on one or both of the front and rear trolleys, which are load trolleys, has the sub-trolley body attached to the trolley frame so as to be rotatable about the first vertical shaft. The left bracket and the right bracket are respectively attached to left and right sides of the sub-trolley body so as to be swingable individually about the first left-right shaft relative to the sub-trolley body. Then, the vertical rollers provided at the front and rear end portions of the left and right brackets roll on the rail.

Accordingly, the four vertical rollers on the front, rear, left, and right of the front sub-trolley and the four vertical rollers on the front, rear, left, and right of the rear sub-trolley can move up and down following the rail, even if the rail on which the vertical rollers roll is curved upward or downward, or even if the rail is installed horizontally but has minute undulations. Accordingly, it can be expected that a surface pressure applied to the rail from each vertical roller is approximately uniform. In addition, the load is borne by eight rollers. Therefore, wear on the rail can be reduced even if heavy loads are conveyed. Specifically, all the eight vertical rollers are securely grounded on the rail so as to bear the load in a distributed manner, thereby preventing premature wear of the rail, and meeting demand for conveying heavy load objects.

In a conveyance device according to a second aspect of the present invention, in the conveyance device of the first aspect, a frame member provided in a lower portion or an upper portion of the object support unit, and each of the trolley frame of the front trolley and the trolley frame of the rear trolley are connected by a fourth left-right shaft so as to be swingable in a vertical direction.

With the configuration of the conveyance device according to the second aspect, even if the rail on which the vertical rollers roll is curved upward or downward, the vertical rollers can closely follow undulations of the rail, thereby allowing the surface pressure applied from the vertical rollers to the rail to be approximately uniform.

In a conveyance device according to a third aspect of the present invention, in the conveyance device of the first aspect, the rail includes a left rail and a right rail, which are in a form of a channel, each of the left rail and the right rail having an opening facing a remaining opening at a distance, and each of the left rail and the right rail includes an upper flange portion or a lower flange portion having, at an edge thereof facing an edge of a remaining flange portion, an upwardly bent edge or a downwardly bent edge for receiving horizontal rollers located at a front and a rear of the sub-trolley body.

In a conveyance device according to a fourth of the present invention, in the conveyance device of the third aspect, the sub-trolley body is positioned between the left rail and the right rail, the vertical rollers at a front and a rear of the left bracket are arranged between the upper flange portion and the lower flange portion of the left rail, the vertical rollers at a front and a rear of the right bracket are arranged between the upper flange portion and the lower flange portion of the right rail, and the horizontal rollers are located above or below the vertical rollers when viewed in a left-right direction.

With the configurations of the conveyance devices according to the third and fourth aspects, main parts of the load trolley can be accommodated between the left rail and the right rail, unlike a conveyance device using a rail with an I-shaped vertical cross section, for example. Thus, an overall height of the conveyance device can be lowered, so that shaking of an object during conveyance is reduced. This improves stability of an object when the object is conveyed by the conveyance device.

With the configuration of the conveyance device according to the fourth aspect, the horizontal rollers are positioned above or below the vertical rollers when viewed in the left-right direction. Accordingly, a distance between the first vertical shaft of the trolley frame in the front sub-trolley and the first vertical shaft of the trolley frame in the rear sub-trolley is shorter than that of a configuration in which the horizontal rollers are arranged in front of and behind the vertical rollers. Therefore, when the rail is curved upward or downward, vertical movement of an object is smaller in the configuration of the conveyance device according to the fourth aspect than that in a configuration in which the horizontal rollers are arranged in front of and behind the vertical rollers. Accordingly, the stability of the object can be improved, and a dimensional change is smaller in comparison with a trolley having the horizontal rollers arranged in front of and behind the vertical rollers. Thus, operational feasibility is improved.

In a conveyance device according to a fifth aspect of the present invention, in the conveyance device of any one of the first aspect to the fourth aspect, the trolley frame has a side surface extending in the front-rear direction, the side surface being a drive surface with which a friction roller of a friction roller drive device is in pressure contact, is arranged to have an approximate same height, relative to the rail, as a connection rod having a side surface serving as a drive surface with which the friction roller is in pressure contact, and is connected to the connection rod so as to be swingable in a vertical direction and a horizontal direction.

With the configuration of the conveyance device according to the fifth aspect, in the conveyance of the carrier by friction roller drive devices, the trolley frame and the connection rods are connected to be swingable in the vertical and horizontal directions. The drive surface of the trolley frame, with which the friction rollers are in pressure contact, and the drive surface of each of the connection rods, with which the friction rollers are in pressure contact, are at approximately the same height relative to the rail. Accordingly, when loads of objects to be conveyed are intended to increase in an existing conveyance device including a load trolley with four vertical rollers on the front, rear, left, and right as in PTL 1, for example, the load trolley according to the present invention, which includes eight vertical rollers, can be substituted without changing the height of the friction roller drive devices installed along the conveyance path, and without significantly modifying the existing conveyance device.

In a conveyance device according to a sixth aspect of the present invention, in the conveyance device of the fifth aspect, the connection rod is extendable and contractive in a length direction thereof and connects the trolley frame of the front trolley and the trolley frame of the rear trolley, and each of the trolley frames of the front trolley and the rear trolley is rotatable about a second vertical shaft at a middle portion of the trolley frame in the front-rear direction relative to the object support unit.

With the configuration of the conveyance device according to the sixth aspect, each connection rod is extendable/contractive in its length direction, and the trolley frames in front of and behind the connection rod are rotatable about the respective second vertical shafts each of which is arranged at a middle portion of the trolley frame in the front-rear direction relative to the object support unit. Therefore, when the carrier moves along the horizontally curved rail, the followability of the vertical rollers to the rail is improved.

With the configuration of the conveyance device according to the fifth aspect or the sixth aspect, the eight-roller load trolley having the front sub-trolley and the rear sub-trolley is used. Therefore, under the same storage pitch condition, an angle toward the center of curvature between the load trolley and the connection rods on a horizontally curved conveyance path becomes larger, in comparison with a case where a conventional trolley having four vertical rollers on the front, rear, left, and right is used.

The carrier may be driven by friction rollers of friction roller drive devices along a horizontally curved conveyance path. In such a situation, when the conveyance device according to the fifth aspect or sixth aspect is used, angular deviation between a direction in which the friction rollers arranged in a curved area of the horizontally curved conveyance path push the connection rods and a direction in which the load trolley moves is reduced, in comparison with a case where a conveyance device using a conventional trolley with four vertical rollers on the front, back, left, and right is used. Therefore, a load applied when the carrier is driven by the friction rollers of the friction roller drive devices along the horizontally curved conveyance path is reduced, so that conveyance failure is less likely to occur.

In a conveyance device according to a seventh aspect of the present invention, in the conveyance device of the third and fourth aspects, the horizontal rollers are attached to the sub-trolley body by a cantilever pin.

With the configuration of the conveyance device according to the seventh aspect, the horizontal rollers are attached to the sub-trolley bodies by means of the cantilever pins, thereby lowering the height of the sub-trolleys. Alternatively, if the height of the sub-trolleys is not lowered, front and rear parts of the sub-trolley body are not required to be thin in the height direction, which is advantageous in terms of strength.

In a conveyance device according to an eighth aspect of the present invention, in the conveyance device of the first aspect, when viewed in a left-right direction, a center of the first left-right shaft is located at an approximate middle point of a line segment connecting a center of the second left-right shaft and a center of the third left-right shaft.

With the configuration of the conveyance device according to the eighth aspect, the center of the first left-right shaft supporting the left bracket and the right bracket so that they can swing relative to the sub-trolley body is located at the approximate midpoint of the line segment connecting the center of the second left-right shaft and the center of the third left-right shaft, the second and third left-right shafts supporting the front and rear vertical rollers in each of the left and right bracket. Accordingly, the front and rear vertical rollers that roll on the rail can move up and down in a seesaw manner. Thus, when heights of the front and rear vertical rollers are not horizontal due to a slope or the like, a horizontal distance between the center of the first left-right shaft and the center of the second left-right shaft is approximately equal to a horizontal distance between the center of the first left-right shaft and the center of the third left-right shaft. Therefore, loads applied to the rail from the front and rear vertical rollers are approximately uniform.

### Advantageous Effects

As described above, in the conveyance device according to the present invention, the four vertical rollers on the front, rear, left, and right of the front sub-trolley and the four vertical rollers on the front, rear, left, and right of the rear sub-trolley can move up and down following the rail, even if the rail on which the vertical rollers roll is curved upward or downward, or even if the rail is installed horizontally but has minute undulations. Accordingly, it can be expected that a surface pressure applied to the rail from each vertical roller is approximately uniform. In addition, the load is borne by eight rollers. Therefore, wear on the rail can be reduced even if heavy loads are conveyed. Specifically, all the eight vertical rollers are securely grounded on the rail so as to bear the loads in a distributed manner, thereby preventing premature wear of the rail, and meeting demand for conveying heavy load objects.

### BRIEF DESCRIPTION OF DRAWINGS

FIG. 1 is a front view with a partial cross-sectional view showing a conveyance device according to an embodiment of the present invention.

FIG. 2 is a vertical cross-sectional view, seen from rear, of the conveyance device according to the embodiment of the present invention.

FIG. 3 is an enlarged front view with a partial cross-sectional view, showing a front trolley and a rear trolley of a load trolley.

FIG. 4 is an enlarged front view with a partial cross-sectional view showing an area around the front trolley.

FIG. 5 is a perspective view of the front trolley.

FIG. 6 is a partially exploded perspective view of the front trolley.

FIG. 7 is a partially exploded perspective view of a front sub-trolley.

FIG. 8 is a front view with a partial cross-sectional view, showing an example of a four-roller load trolley used for one of the front and rear trolleys.

FIG. 9 is a front view with a partial cross-sectional view, showing another example of the four-roller load trolley used for one of the front and rear trolleys.

### DESCRIPTION OF EMBODIMENTS

Hereinafter, embodiments according to the present invention are described with reference to the drawings.

The following description with reference to the drawings is an example in which a conveyance device of the present invention is used on a floor conveyor. The conveyance device of the present invention can also be used in an overhead conveyor.

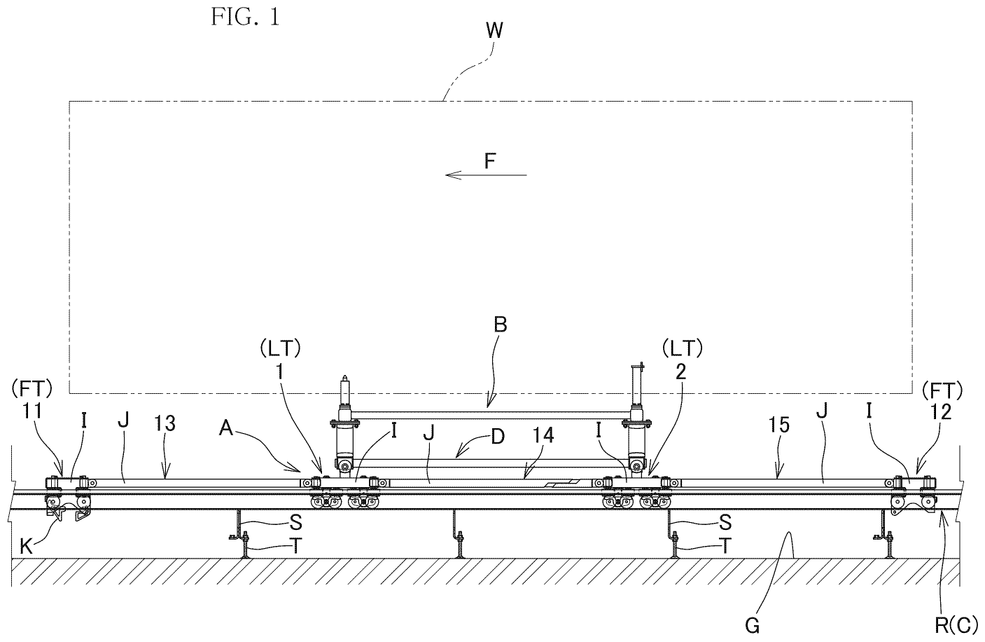

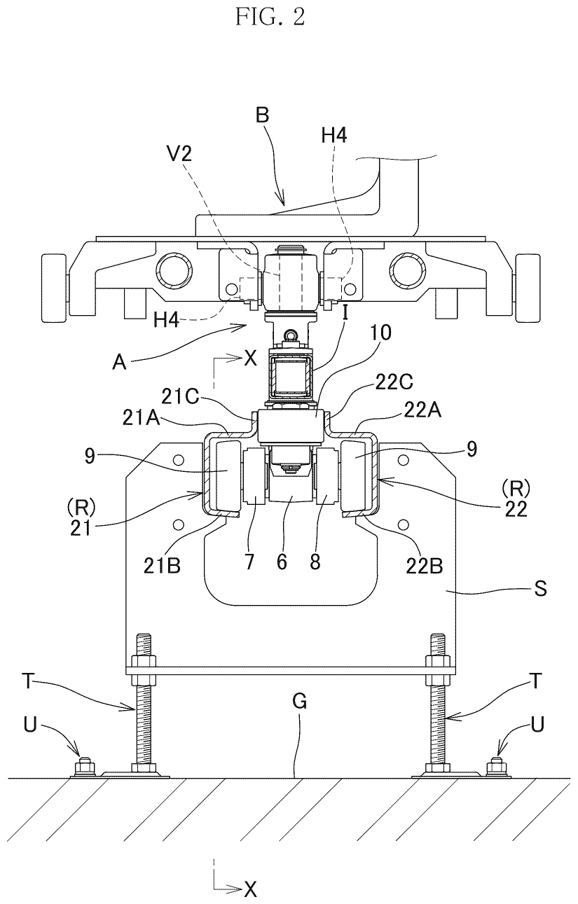

In the description of the specification, a rail is assumed to extend straight and horizontally, and along a conveyance direction (see an arrow F in FIG. 1, for example), a front side (downstream side) is defined as a front, a rear side (upstream side) is defined as a rear, and left and right are defined facing the front. A view from the left is referred to as a front view. The front views each with a partial cross-sectional view in FIGS. 1, 3 and 4 show a cross section taken along the line X-X of FIG. 2.

### [Conveyance Device]

As shown in FIGS. 1 and 2, a conveyance device according to an embodiment of the present invention includes a rail R laid on a predetermined conveyance path C, and a carrier A movable along the rail R.

### [Rail]

The rail R is placed on upper surfaces of support members S and fixed to the support members S by welding or the like. The support member S is laid at a distance above a floor surface G using support bolts T and anchor bolts U.

The rail R includes a left rail 21 and a right rail 22 which have a channel shape and respectively have openings facing each other with a gap between them.

### [Carrier]

The carrier A includes an object support unit B that supports an object W to be conveyed. The carrier A includes load trolleys LT that support the object support unit B, and free trolleys FT that do not support the object support unit B. The load trolleys LT and the free trolleys FT are supported and guided by the rail R.

The carrier A includes, for example, a front end trolley 11 that is the free trolley FT, a front trolley 1 and a rear trolley 2, which are the load trolleys LT, and a rear end trolley 12 that is the free trolley FT.

The front end trolley 11 and the front trolley 1 are connected via a first connection rod 13. The front trolley 1 and the rear trolley 2 are connected via a second connection rod 14. The rear trolley 2 and the rear end trolley 12 are connected via a third connection rod 15.

The front end trolley 11 has an engagement dog K that engages with a traction dog of a power chain drive device. With this configuration, the carrier A can be driven by the power chain drive device.

Each of the front end trolley 11, the front trolley 1, the rear trolley 2, and the rear end trolley 12 has a side surface serving as a drive surface I with which friction rollers of friction roller drive devices are in pressure contact, one by one. Furthermore, each of the first connection rod 13, the second connection rod 14, and the third connection rod 15 has a side surface to serve as a drive surface J with which the friction rollers are in pressure contact. With this configuration, the carrier A can be driven by the friction roller drive devices.

### [Load Trolley]

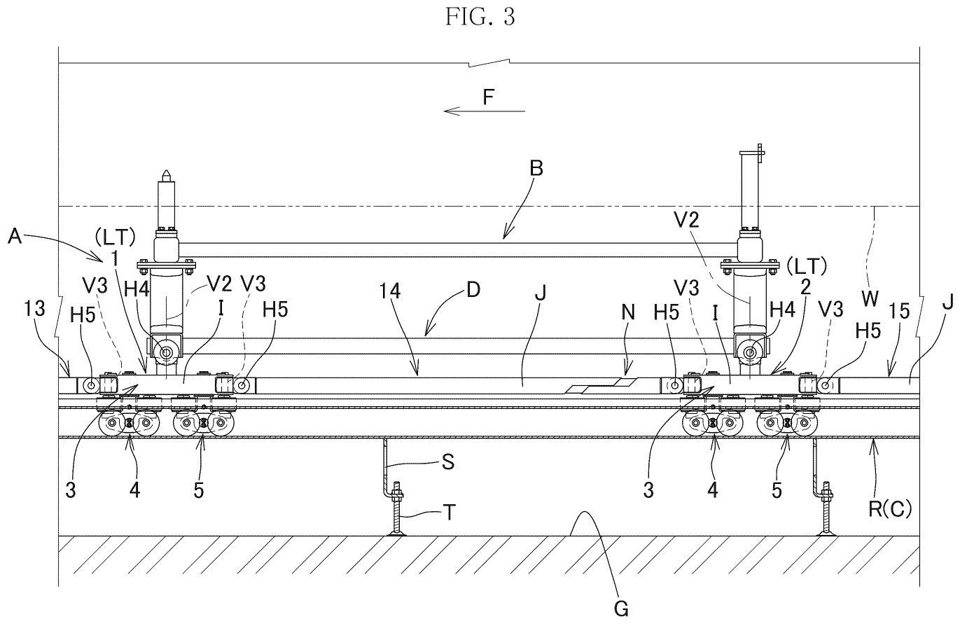

The front trolley 1 and the rear trolley 2 that are the load trolleys LT shown in FIGS. 1 and 3 are identical in structure, and thus the structure of the front trolley 1 will be described.

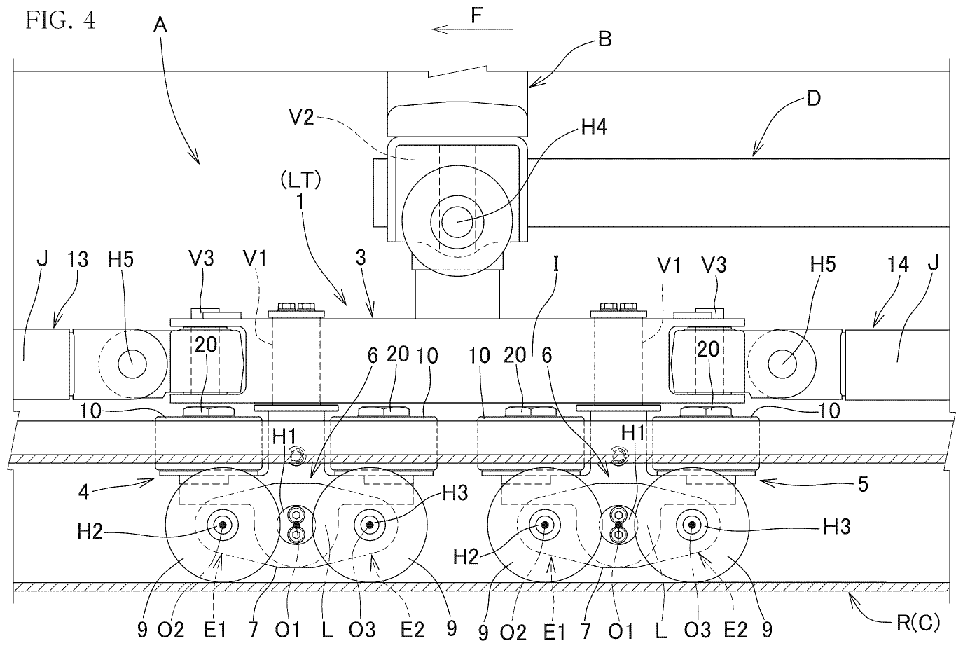

The front trolley 1 shown in FIGS. 4 to 6 includes a trolley frame 3 and a front sub-trolley 4 and a rear sub-trolley 5 respectively positioned at the front and the rear below the trolley frame 3. The front sub-trolley 4 and the rear sub-trolley 5 each have a sub-trolley body 6, a left bracket 7, a right bracket 8, vertical rollers 9, and horizontal rollers 10.

### [Sub-Trolley]

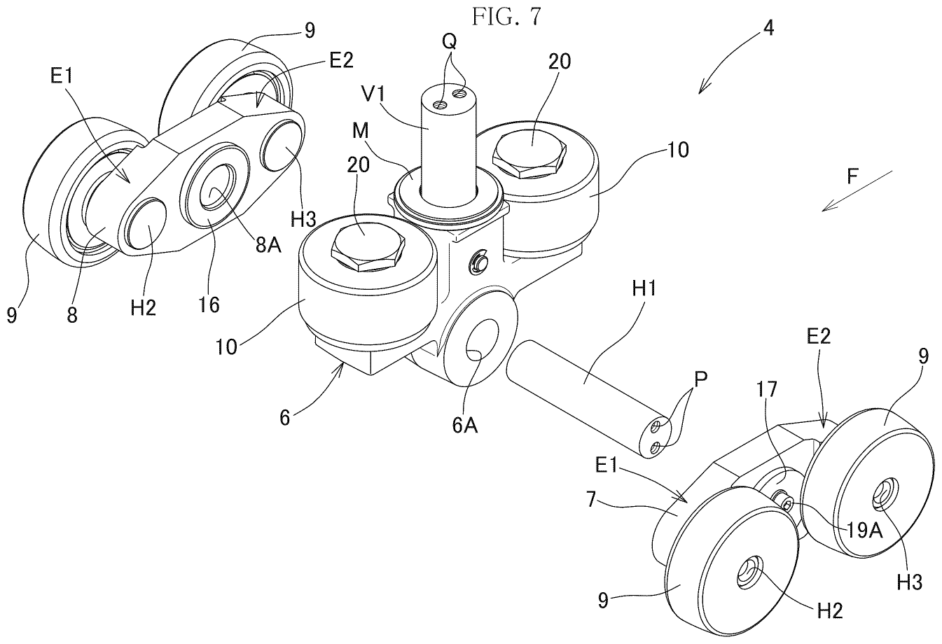

The front sub-trolley 4 and the rear sub-trolley 5 are identical in structure, and thus the structure of the front sub-trolley 4 will be described with mainly reference to FIG. 7.

### (Vertical Roller Support Structure)

A first left-right shaft H1 is inserted through a through hole 6A of the sub-trolley body 6 so as to be attached to the sub-trolley body 6 while being positioned in a left-right direction relative to the sub-trolley body 6. With this configuration, the first left-right shaft H1 is fixed to the sub-trolley body 6 with left and right ends of the first left-right shaft H1 respectively protruding from left and right side surfaces of the sub-trolley body 6.

The left bracket 7 and the right bracket 8 are identical in an attachment structure. The right end of the first left-right shaft H1, which protrudes from the right side surface of the sub-trolley body 6, is inserted into a through hole 8A of the right bracket 8 via a bush 16. In a similar manner, the left end of the first left-right shaft H1, which protrudes from the left side surface of the sub-trolley body 6, is inserted into a through hole (not shown) of the left bracket 7 via a bush (not shown).

A bolt 19A is screwed into each screw hole P at the left end of the first left-right shaft H1 via an attachment plate 17, allowing the left bracket 7 to be attached to the left end of the first left-right shaft H1. In a similar manner, the right bracket 8 is attached to the right end of the first left-right shaft H1. With this configuration, the left bracket 7 is supported so as to be swingable around the first left-right shaft H1 relative to the sub-trolley body 6, and the right bracket 8 is also supported so as to be swingable around the first left-right shaft H1 relative to the sub-trolley body 6.

As described above, the left bracket 7 and the right bracket 8 are respectively positioned on the left and right sides of the sub-trolley body 6, extend in the front-rear direction, are supported at their midpoints in the front-rear direction by the first left-right shaft H1, and swing individually relative to the sub-trolley body 6.

A front vertical roller 9 is attached to a front end E1 of the left bracket 7 to be supported rotatably about a second left-right shaft H2. A rear vertical roller 9 is attached to a rear end E2 of the left bracket 7 to be supported rotatably about a third left-right shaft H3.

A front vertical roller 9 is attached to a front end E1 of the right bracket 8 to be supported rotatably about the second left-right shaft H2. A rear vertical roller 9 is attached to a rear end E2 of the right bracket 8 to be supported rotatably about the third left-right shaft H3.

With reference to FIG. 4, the vertical rollers 9 rolls on the rail R while respectively being supported by the second left-right shaft H2 at the front end E1 and the third left-right shaft H3 at the rear end E2 of each of the left bracket 7 and the right bracket 8. When viewed in the left-right direction, a center O1 of the first left-right shaft H1 is located approximately at the midpoint of a line segment L connecting a center O2 of the second left-right shaft H2 and a center O3 of the third left-right shaft H3.

With this configuration, the front and rear vertical rollers 9 on each of the left bracket 7 and the right bracket 8, which roll on the rail R, can move up and down in a seesaw manner. Accordingly, when heights of the front and rear vertical rollers 9 are not horizontal due to a slope or the like, a horizontal distance between the center O1 of the first left-right shaft H1 and the center O2 of the second left-right shaft H2 is approximately equal to a horizontal distance between the center O1 of the first left-right shaft H1 and the center O3 of the third left-right shaft H3. Therefore, loads applied to the rail R from the front and rear vertical rollers 9 are approximately uniform.

### (Horizontal Roller Support Structure)

Front and rear horizontal rollers 10 are attached to the respective sub-trolley bodies 6 by cantilever pins 20. The horizontal rollers 10 are respectively attached to the sub-trolley bodies 6 by means of the cantilever pins 20, thereby lowering the height of the sub-trolley 4. Alternatively, if the height of the sub-trolley 4 is not lowered, front and rear parts of the sub-trolley body 6 are not required to be thin in the height direction, which is advantageous in terms of strength.

### (First Vertical Shaft)

A first vertical shaft V1 protrudes upward from a center of the sub-trolley body 6 in the front-rear direction. A washer M is attached to the first vertical shaft V1.

### [Attachment of Sub-Trolley to Trolley Frame]

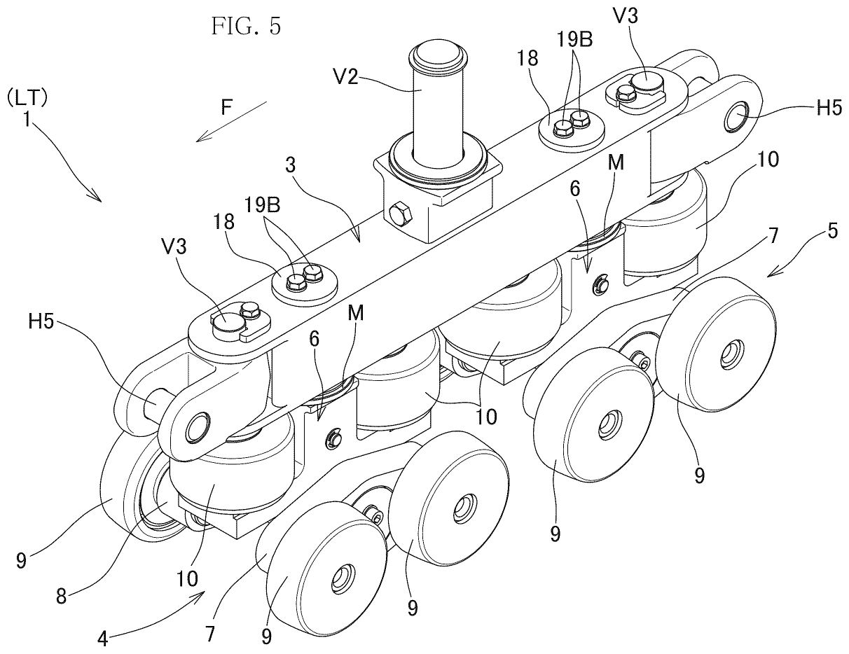

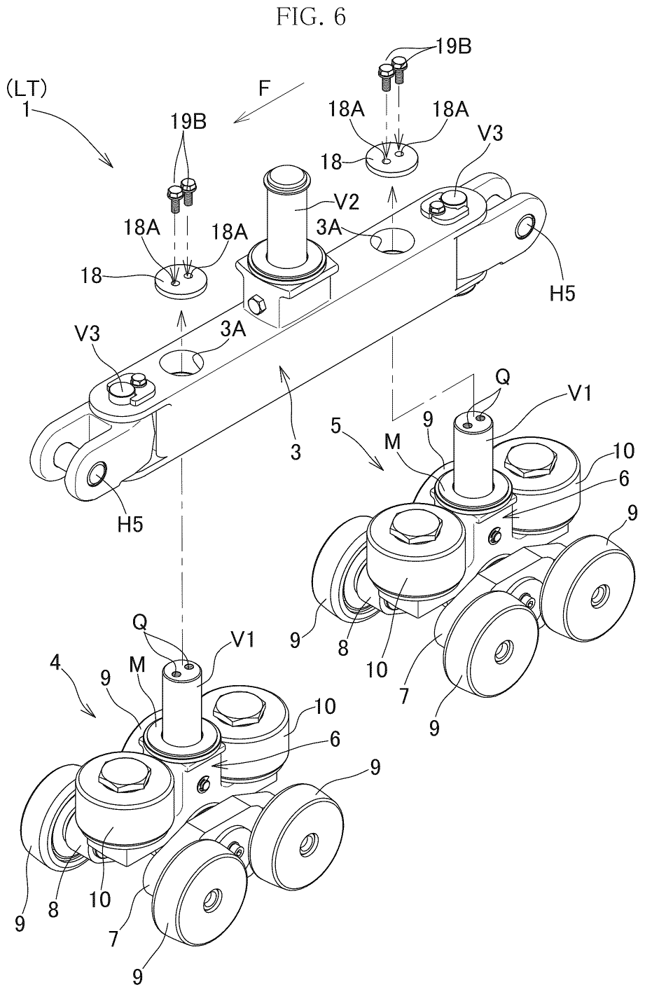

As shown in FIG. 6, the first vertical shaft V1 of the front sub-trolley 4 is inserted from below into a front through hole 3A of the trolley frame 3, and a bolt 19B is inserted from above into each through hole 18A of an attachment plate 18 and screwed into each screw hole Q on an upper end surface of the first vertical shaft V1. With this configuration, the sub-trolley body 6 of the front sub-trolley 4 is attached to the trolley frame 3 as shown in FIG. 5, and is supported rotatably about the first vertical shaft V1 relative to the trolley frame 3.

The first vertical shaft V1 of the rear sub-trolley 5 is inserted from below through a rear through hole 3A of the trolley frame 3, and a bolt 19B is inserted from above through each through hole 18A of an attachment plate 18 and screwed into each screw hole Q on an upper end surface of the first vertical shaft V1. With this configuration, the sub-trolley body 6 of the rear sub-trolley 5 is attached to the trolley frame 3 as shown in FIG. 5, and is supported rotatably about the first vertical shaft V1 relative to the trolley frame 3.

### [Arrangement of Vertical and Horizontal Rollers on Rail]

As shown in FIG. 2, the front and rear vertical rollers 9 of the left bracket 7 are arranged between an upper flange portion 21A and a lower flange portion 21B of the left rail 21, and the front and rear vertical rollers 9 of the right bracket 8 are arranged between an upper flange portion 22A and a lower flange portion 22B of the right rail 22. In addition, the sub-trolley body 6 is positioned between the left rail 21 and the right rail 22.

As shown in FIG. 4, the horizontal rollers 10 are positioned above the vertical rollers 9 when viewed in the left-right direction. As shown in FIG. 2, the horizontal rollers 10 are positioned between an upwardly folded edge 21C extending upward from an inner lateral end of the upper flange portion 21A of the left rail 21 and an upwardly bent edge 22C extending upward from an inner lateral end of the upper flange portion 22A of the right rail 22, so as to be sandwiched between the upwardly folded edges 21C, 22C.

With the configuration of the trolley frame 3, and the front trolley 1 and the rear trolley 2 each including the front sub-trolley 4 and the rear sub-trolley 5, as well as the configuration of the rail R including the left rail 21 and the right rail 22, main parts of the load trolley LT can be accommodated between the left rail 21 and the right rail 22, unlike a conveyance device using a rail with an I-shaped vertical cross section, for example. Thus, an overall height of the conveyance device can be lowered, so that the object W is less likely to be overturned, and therefore shaking of the object W during conveyance is reduced. This improves stability of the object W when the object W is conveyed by the conveyance device.

As shown in FIG. 4, the horizontal rollers 10 are located above the vertical rollers 9 when viewed in the left-right direction. Therefore, a distance between the first vertical shaft V1 of the trolley frame 6 in the front sub-trolley 4 and the first vertical shaft V1 of the trolley frame 6 in the rear sub-trolley 5 is shorter than that in a configuration in which the horizontal rollers 10 are arranged in front of and behind the vertical rollers 9. Accordingly, when the rail R is curved upward or downward, vertical movement of the object W is smaller in the configuration according to the embodiment of the present invention than in the configuration in which the horizontal rollers 10 are arranged in front of and behind the vertical rollers 9. Therefore, the stability of the object W can be improved, and a dimensional change is smaller in comparison with a trolley having the horizontal rollers 10 arranged in front of and behind the vertical rollers 9. Thus, operational feasibility is improved. Here, the meaning of “improved operational feasibility” is as follows: there are certain restrictions and conditions on the conveyance device in the height direction upon installation of a conveyor. Under such a situation, an existing conveyance device is replaced with the conveyance device of the present invention, thereby reducing fluctuation in the vertical direction to allow the conveyance device, which meets the restrictions and conditions, to be feasible.

### [Connection Between Object Support Unit and Load Trolley]

As shown in FIG. 3, a frame material D provided below the object support unit B, the trolley frame 3 of the front trolley 1, and the trolley frame 3 of the rear trolley 2 are connected by a fourth left-right shaft H4 so as to be swingable in the vertical direction. With this configuration, even when the rail R on which the vertical rollers 9 roll is curved upward or downward, the vertical rollers 9 can closely follow the undulations of the rail R, and a surface pressure applied to the rail R by the vertical rollers 9 can be made approximately uniform.

### [Connection of Front and Rear Load Trolleys]

As shown in FIG. 3, each of the trolley frames 3 in the front trolley 1 and the rear trolley 2 has a side surface that extends in the front-rear direction and serves as a drive surface I with which the friction rollers of the friction roller drive devices are in pressure contact, and is positioned so as to be at approximately the same height, relative to the rail R, as the second connection rod 14 that has on its side surface a drive surface J with which the friction rollers are in pressure contact.

The trolley frame 3 of the front trolley 1 is connected to the second connection rod 14 via a fifth left-right shaft H5 and a third vertical shaft V3. In addition, the trolley frame 3 of the rear trolley 2 is connected to the second connection rod 14 via the fifth left-right shaft H5 and the third vertical shaft V3. Specifically, the trolley frame 3 of the front trolley 1 and the second connection rod 14 are connected to be relatively swingable in the vertical and horizontal directions, and the trolley frame 3 of the rear trolley 2 and the second connection rod 14 are connected to be relatively swingable in the vertical and horizontal directions.

Accordingly, when loads of objects to be conveyed are intended to increase in an existing conveyance device including a load trolley with four vertical rollers on the front, rear, left, and right as in PTL 1, for example, the load trolley LT according to the embodiment of the present invention, which includes eight vertical rollers 9 can be substituted, without changing the height of the friction roller drive devices installed along the conveyance path C, and without significantly modifying the existing conveyance device.

As shown in FIG. 3, the second connection rod 14 that connects the front trolley 1 and the rear trolley 2, which are the load trolleys LT, can be extended and retracted in the front-rear direction by a connection portion N. Furthermore, as shown in FIGS. 3 and 4, the trolley frame 3 of the front trolley 1 and the trolley frame 3 of the rear trolley 2 are each rotatable about a second vertical shaft V2 at a middle portion of the trolley frame 3 in the front-rear direction relative to the object support unit B.

Therefore, when the carrier A moves along the horizontally curved rail R, followability of the vertical rollers 9 to the rail R is improved.

### [Effects of Eight-Roller Road Trolley]

In the embodiment of the present invention, the eight-roller load trolley LT having the front sub-trolley 4 and the rear sub-trolley 5 is used, so that under the same storage pitch condition, an angle toward the center of curvature between the load trolley LT and the connection rods 13, 14, 15 on the horizontally curved conveyance path C becomes larger, in comparison with a case where a conventional trolley having four vertical rollers on the front, rear, left, and right is used. Specifically, an angle formed by the first connection rod 13 and the front trolley 1, an angle formed by the front trolley 1 and the second connection rod 14, an angle formed by the second connection rod 14 and the rear trolley 2, and an angle formed by the rear trolley 2 and the third connection rod 15 become large.

The carrier A may be driven by friction rollers of friction roller drive devices along the horizontally curved conveyance path C. In such a situation, when the conveyance device using an eight-roller load trolley LT that has the front sub-trolley 4 and the rear sub-trolley 5, according to the embodiment of the present invention, is used, angular deviation between a direction in which the friction rollers arranged at a curved area in the horizontally curved conveyance path C push the connection rods 13, 14, and 15 and a direction in which the load trolley LT moves is reduced, in comparison with a conveyance device using a conventional trolley with four vertical rollers on the front, back, left, and right. Therefore, a load applied when the carrier A is driven by the friction rollers of the friction roller drive devices along the horizontally curved conveyance path C is reduced, so that conveyance failure is less likely to occur.

The load trolley LT having the eight vertical rollers 9, according to the embodiment of the present invention, includes the trolley frame 3, and the front sub-trolley 4 and the rear sub-trolley 5 which are respectively positioned at the front and the rear below the trolley frame 3. The front sub-trolley 4 and the rear sub-trolley 5 each have the sub-trolley body 6, the left bracket 7, the right bracket 8, and the vertical rollers 9.

The sub-trolley body 6 is attached to the trolley frame 3 so as to be rotatable about the first vertical shaft V1. The left bracket 7 and the right bracket 8 are respectively positioned on the left and right sides of the sub-trolley body 6, extend in the front-rear direction, are supported at their middle portions in the front-rear direction by the first left-right shaft H1, and swing individually relative to the sub-trolley body 6. The vertical rollers 9 roll on the rail R while being respectively supported by the second left-right shafts H2 at the front ends E1 and the third left-right shafts H3 at the rear ends E2 of the left bracket 7 and the right bracket 8.

With this configuration, the four vertical rollers 9 on the front, rear, left, and right of the front sub-trolley 4 and the four vertical rollers 9 on the front, rear, left, and right of the rear sub-trolley 5 can move up and down following the rail R, even if the rail R on which the vertical rollers 9 roll is curved upward or downward, or even if the rail R is installed horizontally but has minute undulations. Accordingly, it can be expected that the surface pressure applied to the rail R from each vertical roller 9 is approximately uniform. In addition, the load is borne by eight rollers. Therefore, wear on the rail R can be reduced even if heavy loads are conveyed. Specifically, the eight vertical rollers 9 are securely grounded on the rail R, thereby preventing premature wear of the rail R, and meeting the demand for conveying heavy load object W.

### [Modification]

In the above embodiment, both the front trolley 1 and the rear trolley 2, which are the load trolleys LT, are equipped with the eight vertical rollers 9 shown in FIGS. 5 and 6 (the load trolley with eight rollers), as shown in FIG. 3. Here, the present invention is not limited to such a configuration, and it is also possible that only one of the front trolley 1 and the rear trolley 2 is the road trolley with the eight rollers. For example, if the load of the object W is applied more heavily to the front, only the front trolley 1 may be the eight-roller load trolley, and if the load of the object W is applied more heavily to the rear, only the rear trolley 2 may be the eight-roller load trolley.

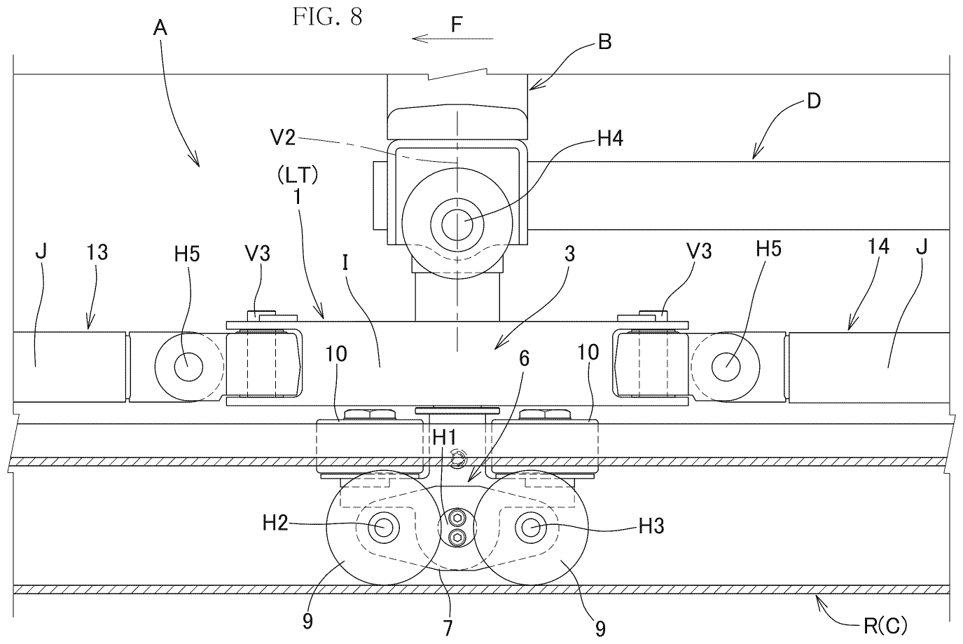

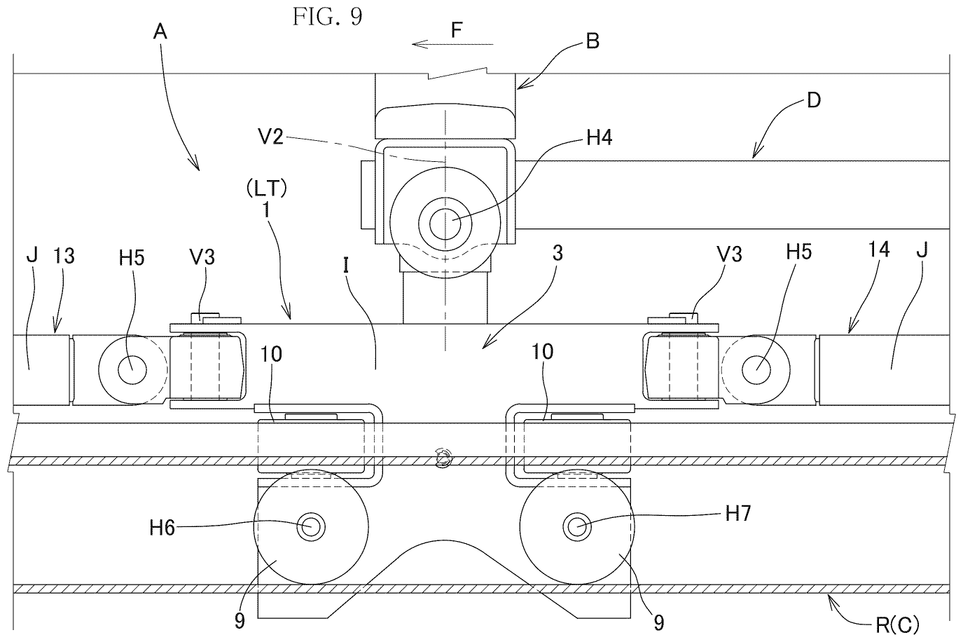

When only one of the front trolley 1 and the rear trolley 2 is a load trolley with eight rollers, the other trolley is equipped with four vertical rollers 9 (a load trolley with four rollers). Examples of the four-roller road trolley are shown in FIGS. 8 and 9. FIGS. 8 and 9 show an example in which the load of the object W is biased rearward and only the rear trolley 2 is the eight-roller load trolley.

The four-roller load trolley LT shown in FIG. 8 is an example in which a single sub-trolley having a structure similar to the front sub-trolley 4 and rear sub-trolley 5 shown in FIG. 6 is provided below the trolley frame 3. The four-roller load trolley LT shown in FIG. 9 shows an example in which the vertical rollers 9 are attached to both ends of a sixth left-right shaft H6 and a seventh left-right shaft H7 at the front and the rear, which pass through the trolley frame 3 that is the base body.

When the conveyance device of the present invention is used in an overhead conveyor, a structure of the rail laid on a specified conveyance path and the carrier movable along the rail is upside down relative to a case in which the conveyance device of the present invention is used in the floor conveyor.

Specifically, the rail is prepared by turning upside down the rail shown in FIG. 2, and is supported by a support member supported on a ceiling or the like. The rail includes left and right rails in a form of a channel with openings facing each other at a distance, and opposing edges of the respective lower flanges of the left and right rails have downwardly bent edges for receiving horizontal rollers.

The carrier is prepared by turning upside down the carrier shown in FIG. 2 to FIG. 4, and the frame material D is provided on an upper part of the object support unit B. The eight-roller load trolley provided on the carrier includes a trolley frame, and a front sub-trolley and a rear sub-trolley which are positioned at the front and the rear above the trolley frame. The horizontal rollers are positioned below the front, rear, left, and right vertical rollers when viewed in the left-right direction.

The above description of the embodiments is merely illustrative, and the present invention is not limited thereto. Various modifications and variations can be made without departing from the scope of the present invention.

1. A conveyance device comprising:
a rail laid on a predetermined conveyance path; and
a carrier movable along the rail, wherein
the carrier includes:
an object support unit that supports an object to be conveyed; and
a front trolley and a rear trolley that are load trolleys supporting the object support unit,
at least one of the front trolley and the rear trolley includes:
a trolley frame; and
a front sub-trolley and a rear sub-trolley respectively positioned at a front and a rear of the trolley frame above or below the trolley frame,
each of the front sub-trolley and the rear sub-trolley includes a sub-trolley body, a left bracket, a right bracket, and vertical rollers,
the sub-trolley body is attached to the trolley frame so as to be rotatable about a first vertical shaft,
the left bracket and the right bracket are respectively positioned on a left side and a right side of the sub-trolley body to extend in a front-rear direction, each of the left bracket and the right bracket being supported at a middle position thereof in the front-rear direction by a first left-right shaft, and swinging relative to the sub-trolley body, and
each of the vertical rollers is supported by a second left-right shaft at a front end portion of each of the left bracket and the right bracket, and a third left-right shaft at a rear end portion of each of the left bracket and the right bracket, and rolls on the rail.

2. The conveyance device according to claim 1, wherein
a frame member provided in a lower portion or an upper portion of the object support unit, and each of the trolley frame of the front trolley and the trolley frame of the rear trolley are connected by a fourth left-right shaft so as to be swingable in a vertical direction.

3. The conveyance device according to claim 1, wherein
the rail includes a left rail and a right rail, which are in a form of a channel, each of the left rail and the right rail having an opening facing a remaining opening at a distance, and
each of the left rail and the right rail includes an upper flange portion or a lower flange portion having, at an edge thereof facing an edge of a remaining flange portion, an upwardly bent edge or a downwardly bent edge for receiving horizontal rollers located at a front and a rear of the sub-trolley body.

4. The conveyance device according to claim 3, wherein
the sub-trolley body is positioned between the left rail and the right rail,
the vertical rollers at a front and a rear of the left bracket are arranged between the upper flange portion and the lower flange portion of the left rail,
the vertical rollers at a front and a rear of the right bracket are arranged between the upper flange portion and the lower flange portion of the right rail, and
the horizontal rollers are located above or below the vertical rollers when viewed in a left-right direction.

5. The conveyance device according to claim 1, wherein
the trolley frame
has a side surface extending in the front-rear direction, the side surface being a drive surface with which a friction roller of a friction roller drive device is in pressure contact,
is arranged to have an approximate same height, relative to the rail, as a connection rod having a side surface serving as a drive surface with which the friction roller is in pressure contact, and
is connected to the connection rod so as to be swingable in a vertical direction and a horizontal direction.

6. The conveyance device according to claim 2, wherein
the trolley frame
has a side surface extending in the front-rear direction, the side surface being a drive surface with which a friction roller of a friction roller drive device is in pressure contact,
is arranged to have an approximate same height, relative to the rail, as a connection rod having a side surface serving as a drive surface with which the friction roller is in pressure contact, and
is connected to the connection rod so as to be swingable in a vertical direction and a horizontal direction.

7. The conveyance device according to claim 3, wherein
the trolley frame
has a side surface extending in the front-rear direction, the side surface being a drive surface with which a friction roller of a friction roller drive device is in pressure contact,
is arranged to have an approximate same height, relative to the rail, as a connection rod having a side surface serving as a drive surface with which the friction roller is in pressure contact, and
is connected to the connection rod so as to be swingable in a vertical direction and a horizontal direction.

8. The conveyance device according to claim 4, wherein
the trolley frame
has a side surface extending in the front-rear direction, the side surface being a drive surface with which a friction roller of a friction roller drive device is in pressure contact,
is arranged to have an approximate same height, relative to the rail, as a connection rod having a side surface serving as a drive surface with which the friction roller is in pressure contact, and
is connected to the connection rod so as to be swingable in a vertical direction and a horizontal direction.

9. The conveyance device according to claim 5, wherein
the connection rod is extendable and contractive in a length direction thereof and connects the trolley frame of the front trolley and the trolley frame of the rear trolley, and
each of the trolley frames of the front trolley and the rear trolley is rotatable about a second vertical shaft at a middle portion of the trolley frame in the front-rear direction relative to the object support unit.

10. The conveyance device according to claim 3, wherein
the horizontal rollers are attached to the sub-trolley body by a cantilever pin.

11. The conveyance device according to claim 4, wherein
the horizontal rollers are attached to the sub-trolley body by a cantilever pin.

12. The conveyance device according to claim 1, wherein
when viewed in a left-right direction, a center of the first left-right shaft is located at an approximate middle point of a line segment connecting a center of the second left-right shaft and a center of the third left-right shaft.
